(19) United States
(12) Patent Application Publication
(10) Pub. No.: US 2006/0242849 A1
(43) Pub. Date: Nov. 2, 2006

(54) TOOL FOR MARKING WEIGHT ATTACHMENT LOCATION ON WHEEL

(76) Inventors: Robert D. Fogal SR., Chambersburg, PA (US); Robert D. Fogal JR., Newville, PA (US)

Correspondence Address: HAHN LOESER & PARKS, LLP, One GOJO Plaza, Suite 300, AKRON, OH, 44311-1076, US

(21) Appl. No.: 11/164,717

(22) Filed: Dec. 2, 2005

Related U.S. Application Data
(63) Continuation-in-part of application No. 10/806,671, filed on Mar. 23, 2004, now Pat. No. 6,979,060.
(60) Provisional application No. 60/488,634, filed on Jul. 18, 2003.
(60) Provisional application No. 60/632,411, filed on Dec. 2, 2004.

(51) Int. Cl. B43L 13/02

(52) U.S. Cl. 33/42

(57) ABSTRACT

A tool for marking an arc or annular line for facilitating the proper positioning of an adhesively attached arcuate weight to the brake well or tube well of a wheel or other rotating member is provided. The tool comprises a base member having a register surface for engaging the rim flange of the wheel, a bar extending from the base and spaced from the register surface of the base, and a marker removably attachable to the bar, the marker extending from the bar and adapted to mark the wheel when the register surface of the base engages the rim flange of the wheel.

This application claims the benefit of U.S. provisional application 60/632,411, filed Dec. 2, 2004, hereby incorporated by reference. This application is also a continuation-in-part of U.S. non-provisional patent application Ser. No. 10/806,671, filed Mar. 23, 2004, which claims the benefit of U.S. provisional patent application Ser. No. 60/488,634, filed Jul. 18, 2003, both applications hereby incorporated by reference.

### TECHNICAL FIELD

This invention relates to a tool for marking a line on a wheel in order to properly position one or more weights and, more particularly, it relates to a tool for marking an arc or annular line for facilitating the proper positioning of an adhesively attached arcuate weight to the brake well or tube well of a wheel or other rotating member.

### DESCRIPTION OF THE PRIOR ART

Tire/wheel assemblies are typically balanced using lead balance weights that clip on to the flange of the wheel. These prior art lead balance weights are fixed in position by an operator as directed by a spin balance machine. A problem with this method is that the lead balance weights may be attached to the wheel slightly off position by the operator. This requires the operator to rebalance. Additionally, once the tire/wheel assembly is in operation on the vehicle, tire wear, pot holes, etc. will cause the tire/wheel assembly to go out of balance. Another problem with these standard balance weights is that they are unsightly and often cause wheel corrosion due to the effect of dissimilar metals.

Tape on weights have also been used in an attempt to hide the weights in the brake well or other wheel locations that are not as visible as the wheel flange. Tape on weights typically come in a strip and the user breaks the strip depending on the amount of weight needed. The tape weights come with a covered adhesive backing. The covering is removed and the tape weights are typically positioned in an arc in the wheel brake well. The more weight that is needed, the longer the length of the tape weight to be attached to the wheel. It is often difficult for the operator to properly place the long tape weight along an arc in a radial plane of the wheel. The elongated tape on weights are therefore more easily mispositioned on the wheel than standard clip on weights and, once attached, are difficult to remove. Mispositioning of the weights can add to the imbalance of the tire/wheel assembly instead of reducing imbalance.

A newer balancing product is Xact Balance™, an arcuate balance weight cartridge as known from the Applicant's co-owned U.S. patent application Ser. No. 10/806,671, filed Mar. 23, 2004, entitled Balance Weight Cartridge with Enclosed Balance Media, hereby incorporated by reference. In contrast to standard rim attached balance weights, the cartridge style balance weight allows the weight of the enclosed flowable media to move circumferentially as well as laterally within the cartridge. The wheel balance machine operator attempts to center the cartridge style balance weight at the location specified by the spin balance machine. If the operator misses the exact balance location slightly, the flowable media is able to adjust the effective balance location of the tire/wheel assembly by moving within the cartridge to obtain a balance equilibrium. Accordingly, the balance weight operator need not be as accurate, and the tire/wheel assembly stays in balance even during operation of the tire/wheel assembly as the balance location moves along the wheel.

However, arcuate weights, whether tape or cartridge style, should be positioned in a radial plane that is perpendicular to the axis of rotation of the wheel and preferably through the radial centerline of the wheel. This can be difficult as the amount of weight required increases making the weight longer.

Therefore, it would be an advantage to provide a tool and method for properly locating arcuate weights on a wheel.

### SUMMARY OF THE INVENTION

The present invention overcomes at least one disadvantage identified in the prior art by providing a tool for marking a surface of a wheel having a rim flange, the tool comprising: a base member having a register surface for engaging the rim flange of the wheel; a bar extending from the base and spaced from the register surface of the base; a marker removably attachable to the bar, the marker extending from the bar and adapted to mark the wheel when the register surface of the base engages the rim flange of the wheel.

At least one advantage is also provided by a method of attaching a weight to a tire/wheel assembly comprising the steps of: providing a tire/wheel assembly; providing a tool comprising a base member having a register surface for engaging the rim flange of the wheel, a bar extending from the base and spaced from the register surface of the base, and a marker removably attachable to the bar, the marker extending from the bar; positioning the register surface of the base of the tool against the rim flange of the wheel such that the marker contacts the non-pressurized side of the tubewell of the tire/wheel assembly; moving either the tool or the wheel to mark at least an arc on the non-pressurized side of the tubewell of the tire/wheel assembly; providing at least one weight, wherein the weight is longitudinally arcuate, at least when attached to the tire/wheel assembly; and attaching the at least one weight to the non-pressurized side of the tubewell of the tire/wheel assembly along the marked arc.

At least one advantage is also provided by a method of balancing a tire/wheel assembly comprising the steps of: providing a tire/wheel assembly; providing a tool comprising a base member having a register surface for engaging the rim flange of the wheel, a bar extending from the base and spaced from the register surface of the base, and a marker removably attachable to the bar, the marker extending from the bar; determining a weight amount of an imbalance of the tire/wheel assembly and a location to correct the imbalance of the tire/wheel assembly using a tire/wheel assembly balancing equipment; positioning the register surface of the base of the tool against the rim flange of the wheel such that the marker contacts the non-pressurized side of the tubewell of the tire/wheel assembly; moving either the tool or the wheel to create at least an arc marking on the non-pressurized side of the tubewell of the tire/wheel assembly; providing at least one weight comprising a cartridge comprising an interior chamber at least partially filled with a flowable media, wherein the cartridge is longitudinally arcuate, at least when attached to the tire/wheel assembly, about an angle of 180 degrees or less; and attaching the at least one weight to the non-pressurized side of the tubewell of the tire/wheel assembly along the arc marking at the location to correct the imbalance of the tire/wheel assembly.

These and other advantages will be apparent upon a review of the detailed description of the present invention.

### BRIEF DESCRIPTION OF THE DRAWINGS

FIG. 1 shows a side elevational view of the tool of the present invention;

FIG. 2 shows an opposite side elevational view of the tool of the present invention;

FIG. 3 shows a top elevational view of the tool of the present invention;

FIG. 4 shows an exploded view of the components of the tool of the present invention;

FIG. 5 shows a side elevational view of the extension bar used in the tool of the present invention;

FIG. 6 is an exploded side view of a cartridge-style balance weight;

FIG. 7 is a longitudinal cross-sectional view of an assembled cartridge-style balance weight;

FIG. 8 shows a step of cleaning the non-pressurized side of the wheel well of a tire/wheel assembly;

FIG. 9 shows a step of marking an arc on the non-pressurized side of the wheel well of a tire/wheel assembly;

FIG. 10 shows a step of placing a balance weight adjacent the arc shown in FIG. 9;

FIG. 11 shows a step of balancing out a balance machine;

FIG. 12 shows an alternate embodiment of the present invention showing a step of placing a second balance weight adjacent an arc;

FIG. 13 shows a step of marking a line 360 degrees about the non-pressurized side of the wheel well of a tire/wheel assembly; and

FIG. 14 shows an alternate embodiment of the present invention showing a step of placing two 180 degree balance weights adjacent a balance weight.

### DETAILED DESCRIPTION OF THE INVENTION

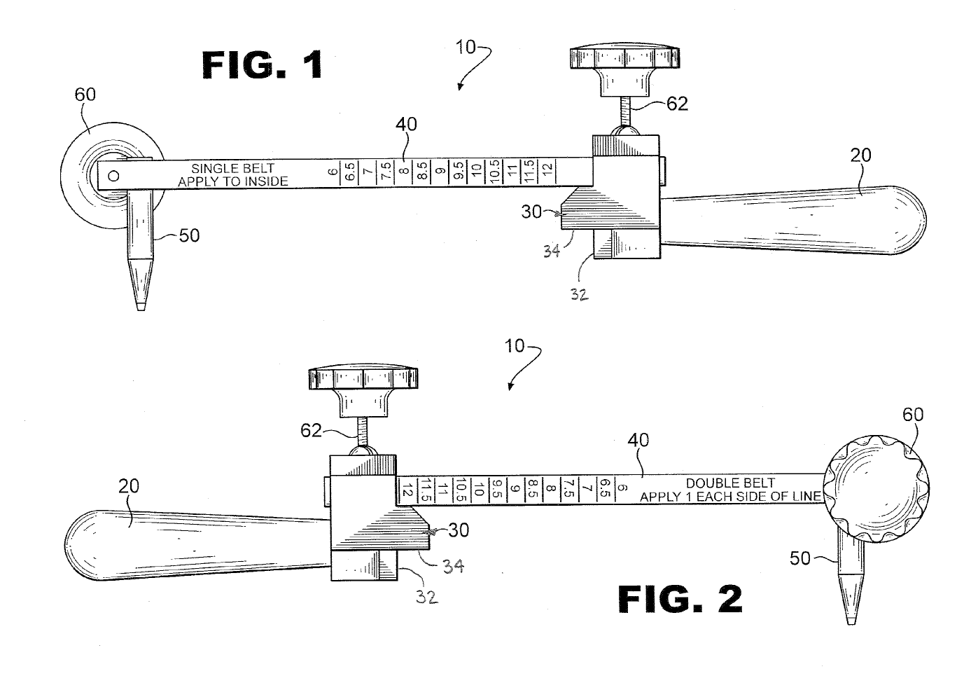

The tool 10 of the present invention is shown in a side elevational view in FIG. 1 and comprises a handle 20, a tool body 30, an extension bar 40, and a marker 50. The marker 50 is adjustably positioned in an aperture 42 in the extension bar 40 and secured in position by a threaded screw 60. The extension bar 40 is slidably positioned through an aperture in the tool body 30 and secured in position by a threaded screw 62. Base 30 includes a register surface 32 that registers against the rim flange of a wheel as discussed later. The marker 50 is typically a grease pen or the like, however, it is contemplated that the marker can be any object that can leave a visible mark on the surface of the wheel. A second surface 34 of the base 30 can be used to radially position tool 10 against the brake wheel well as also discussed below. FIG. 2 shows an opposite side elevational view of the tool 10.

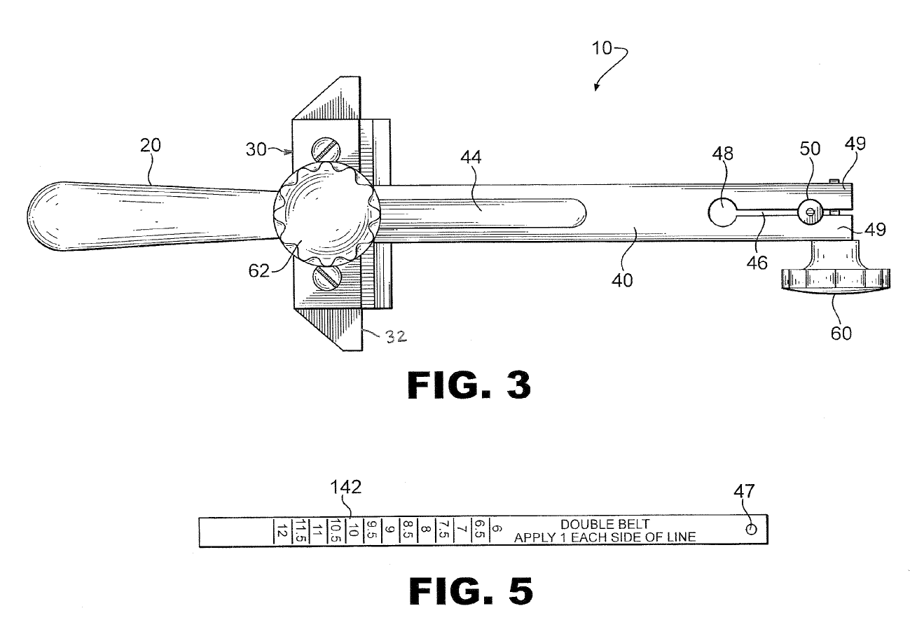

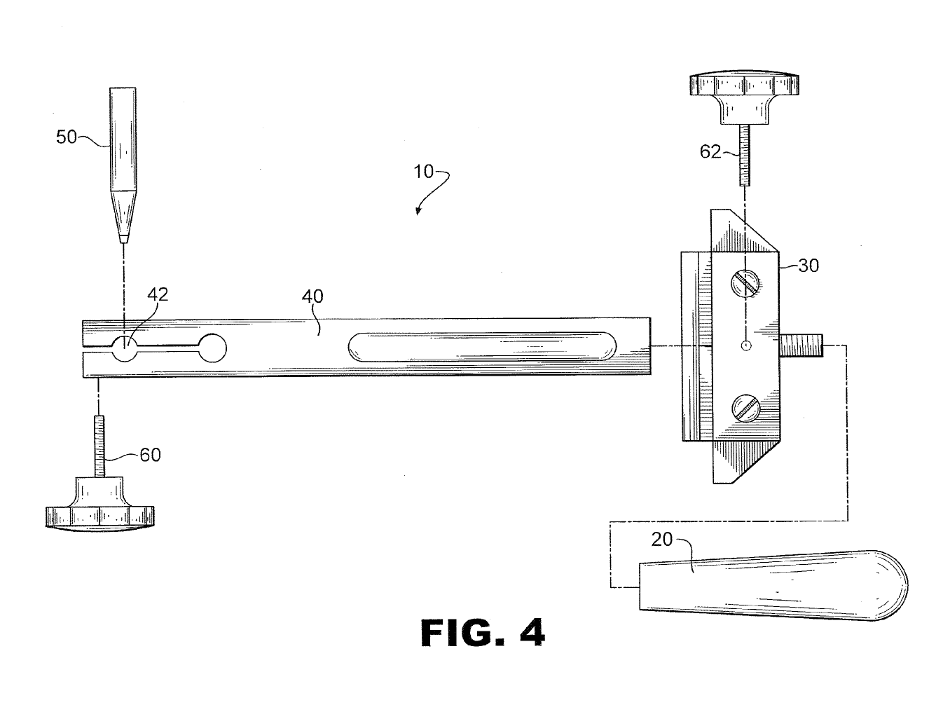

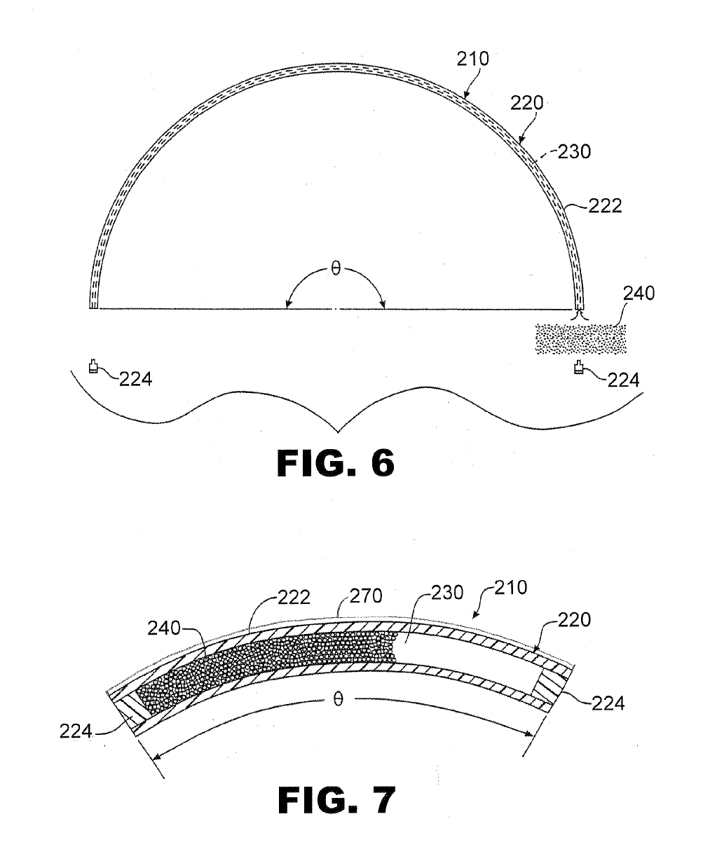

In the top view of FIG. 3 there is shown a slot 44 in the extension bar 40 into which the end of threaded screw 62 engages to secure the extension bar 40 to the body 30. The extension bar 40 also comprises a through slot 46 extending from an aperture 48 along the centerline of the bar 40 and through aperture 42 and to the end of the bar 40. This creates two cantilever portions 49 of the bar 40. A transverse aperture 47 best shown in FIG. 7 extends through each cantilever portion 49 such that the threaded screw 60 clamps the cantilever portions 49 together to secure a marker 50 positioned within aperture 42. In FIG. 4, the top view of the tool 1 0 is shown in an exploded view wherein the handle 20 is shown demountably attached to the body 30.

FIG. 5 is a detailed view of the extension bar 40 showing graduations 142 associated with different wheel rim sizes. The side of the bar 40 shown is for a double layer of arcuate weights wherein the weights will be positioned side by side on either side of a line marked on the wheel by the tool 10. The opposite side of the bar 40 is for single layer of arcuate weights and is best shown in FIG. 1. This single layer side has graduations that are slightly offset (typically by an amount that is one half of the axial width of the arcuate weight) from the graduations on the double layer side such that the user placing the weights on a predetermined side of the line marked on the wheel will properly center the weights on the radial centerline of the wheel.

The tool 10 can be used with metallic tape weights, however, the tool 10 is particularly useful with the Xact Balance™ balance weights previously mentioned as Applicant's co-owned U.S. patent application Ser. No. 10/806,671. Referring now to FIGS. 6 and 7, an exploded view and an assembled cross-sectional view, respectively, the balance weight 210 comprising a hollow body or cartridge 220 having a interior chamber 230 at least partially filled with a flowable media 240. The cartridge 220 forms a container and is typically made of a molded or extruded rubber or plastic material that will not react with the metallic surface of a wheel. The cartridge 220 comprises a tube 222 that may be cut or molded to the desired length. The flowable media 240 is inserted in the tube 222 which is then sealed, most commonly with at least one plug 224 or a heat weld seal may also be used. The cartridge 220 may be formed in a rigid longitudinally arcuate section of an angle θ equivalent to an angle of one hundred eighty degrees or less, or it may be formed in a flexible straight section and positioned into an arcuate section of one hundred eighty degrees or less when attached to a wheel as described in greater detail below. The walls of the tube 222 which make up the interior chamber 230 should be of a smooth surface finish that will promote flow of the flowable media 240. The tube 222 may be any suitable cross-sectional shape, however, the physical exterior dimension or height of the tube 222 should be chosen such that it does not interfere with other systems positioned near the tire/wheel assembly such as the braking system, etc. Adhesive strip 270 is provided on the exterior of tube 220 to provide means for attaching the tube 222 to the wheel. The flowable material 240 may be metallic balls, preferably stainless-steel, however any suitable flowable material is contemplated by the present invention including beads, shot, particles, powders, etc. made of ferrous and non-ferrous metals, ceramics, plastics, glass beads, alumina, etc. It is also contemplated that the flowable material may be a liquid, in whole or in part. Such suitable materials include any material that is stable and remains free flowing over all operating conditions of the tire/wheel assembly. The size of the individual material of the flowable material 240 must be small enough that it can flow in an interior chamber 230 having a relatively small height. The amount of flowable material 240 within the balance weight 210 should be sufficient to enable the balance weight 210 to balance the tire/wheel assembly. It is generally contemplated that the amount of flowable material 240 used in a cartridge 220 will vary between 5 to 95 percent of the volume of the internal chamber 230. In one embodiment, the amount of flowable material 240 as shown is approximately two-thirds of the volume of the internal chamber 230, which has been shown to provide optimized dynamic balancing during current testing, however any amount sufficient to allow the flowable material to sufficiently move and balance the tire/wheel assembly is contemplated. In some applications where the lead balance weight is merely replaced, the entire volume of the interior chamber can be filled with material 240 such that the balance weight 210 acts as a fixed weight.

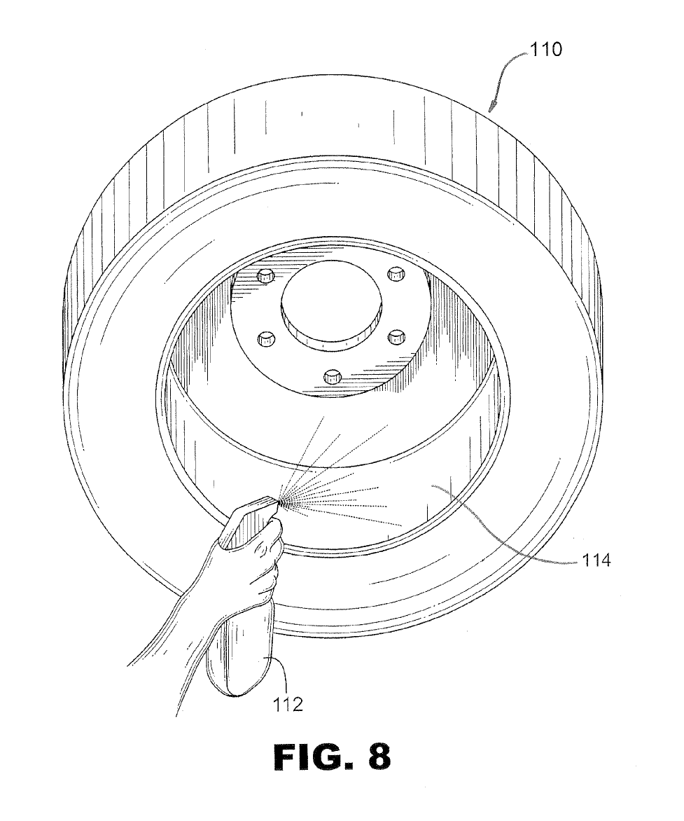

Referring now to FIGS. 8-12 at least one method of the present invention is shown. In FIG. 8, the area of attachment of the balance weight, in this case the brake well 114 of the tire wheel assembly 110, is prepared using a suitable wheel cleaner 112. This step, although in some cases may not be required, is recommended when the wheel brake well 114 (also referred to as the non-pressurized side of the tubewell) is not clean so that the adhesive 270 of the wheel weight 210 will properly adhere to the surface of the wheel brake well 114.

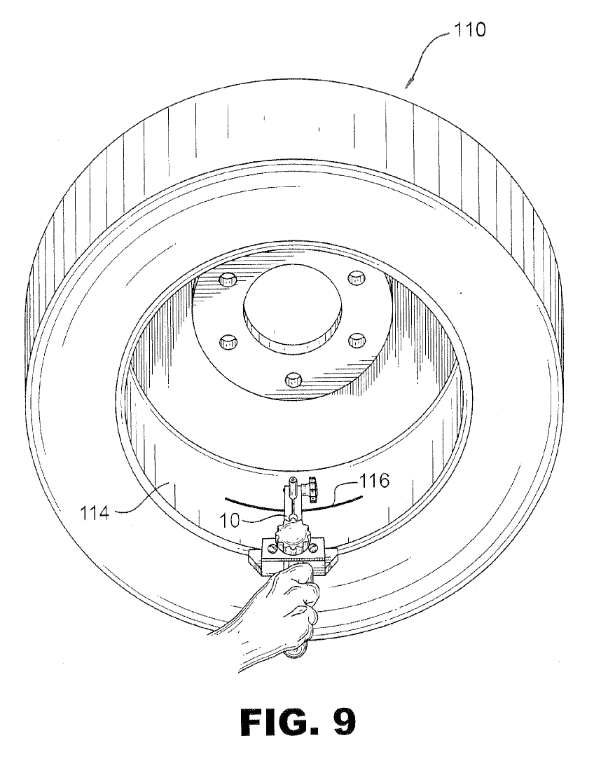

In FIG. 9, the step of marking the tire is shown. The tool 10 is adjusted to the size of the wheel by extending the bar 40 from the base 30 at a graduation 142 corresponding to the width of the wheel rim and fixing the bar 40 to the tool base 30 using the screw 62. The register face 32 of the base 30 is placed against the base of the rim flange such that the extension bar 40 extends into the wheel brake well 114. The base 30 also has a surface 34 that engages the surface of the brake well 114 (or the top of the flange if the tool 10 was used to mark the pressurized side of the tube-well) that helps position the tool 10 during marking. The marker 50 should be positioned such that marking end is in contact with the wheel brake well 114. Either the tool 1 0 or the wheel is then rotated about an arc of up to 360 degrees, keeping the register surface against the base of the wheel flange and keeping the marker 50 in contact with the wheel brake well 114 such that an annular line is made on the wheel brake well 114.

In the next step, the tire/wheel assembly 110 is mounted on the spin balancer and the out of balance condition is detected as is well known in the art. The spin balancer recommends an amount of weight to be positioned at a particular circumferential position and at a particular predetermined distance from the axis in one or more predetermined planes. When attaching weights to the brake side of the tube well, some operators will often use single plane balancing using the tire/wheel assembly centerline as “good enough”, however most newer balancing machines can still utilize dual plane balancing by providing dual planes along the surface of the brake side of the tube well. Direct measure balance weight placement and 360 degree weight placement display capabilities make positioning balance weight 210 both simple and accurate to balance the tire/wheel assembly 110. The method of the present invention can be utilized with both procedures.

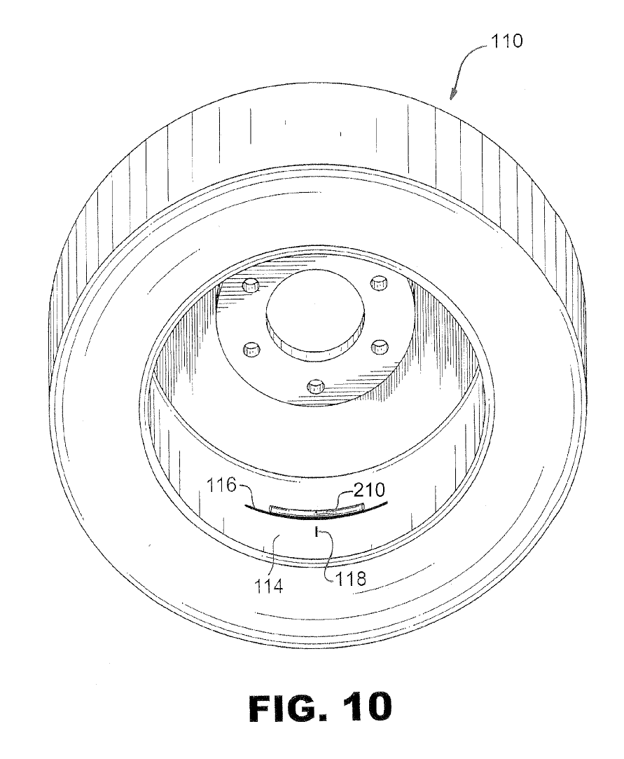

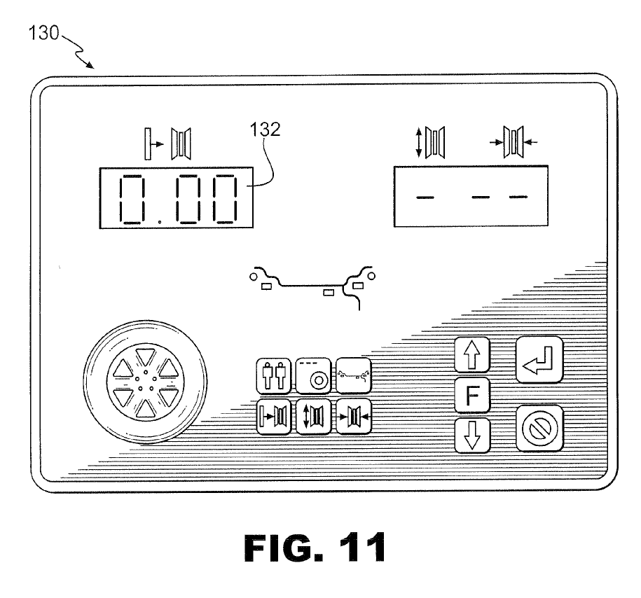

Referring now to FIG. 10, the radial location of imbalance 118 is marked by the operator near the marked arc 116. The balance weight 210 is then attached to the wheel adjacent the marked arc 116 and centered on the radial location of imbalance 118. The balance weight 210 is preferably positioned on the side of the line such that the longitudinal centerline of the arcuate weight 210 coincides with the radial centerline of the wheel. The tire/wheel assembly 110 is again mounted on the spin balancer and the balanced condition is verified by a zero reading 132 on the spin balancer operator screen 130 as shown in FIG. 11.

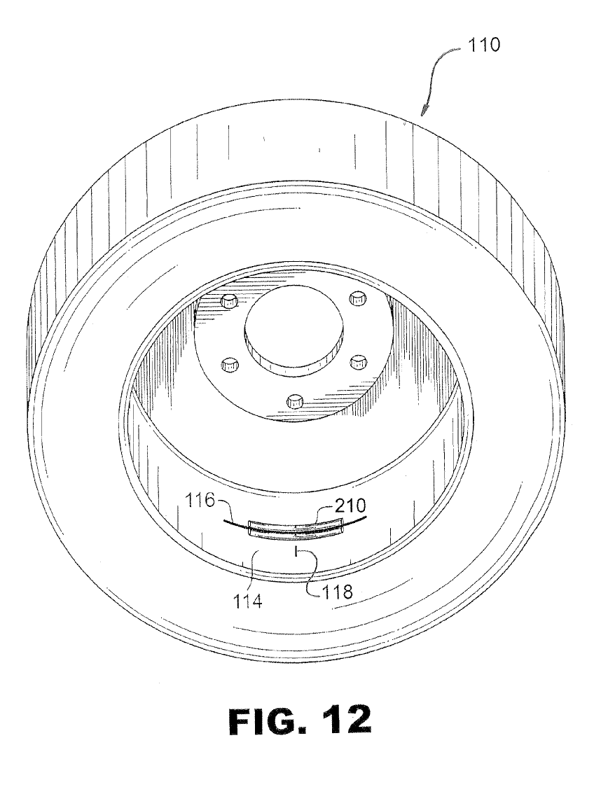

In some situations, it may be advantageous to position two balance weights adjacent each other at the same radial location such as when a larger amount of weight may be needed to balance the tire/wheel assembly 110. Referring now to FIG. 12, a second balance weight 210 is shown attached adjacent to the first balance weight 210 on the opposite side of the marked arc 116. When using double weights as shown, it is preferable that the marked arc 116 is marked coincident with the radial centerline of the wheel using the appropriate graduations 142 on tool 10.

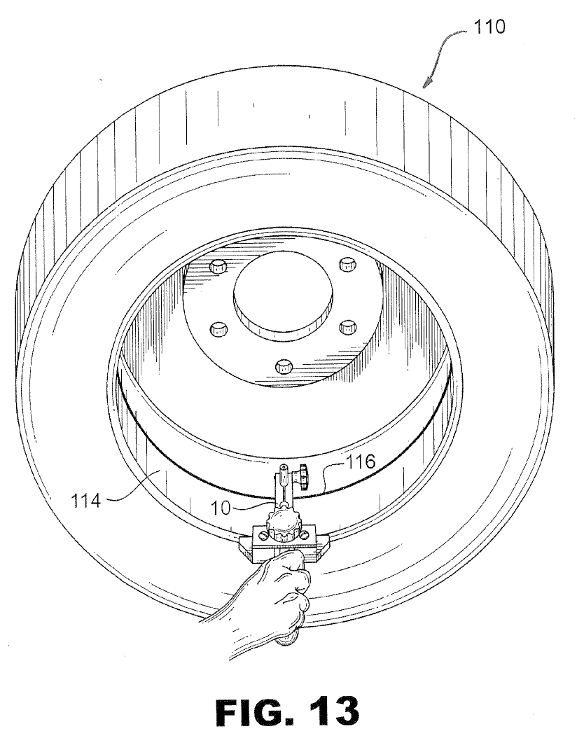

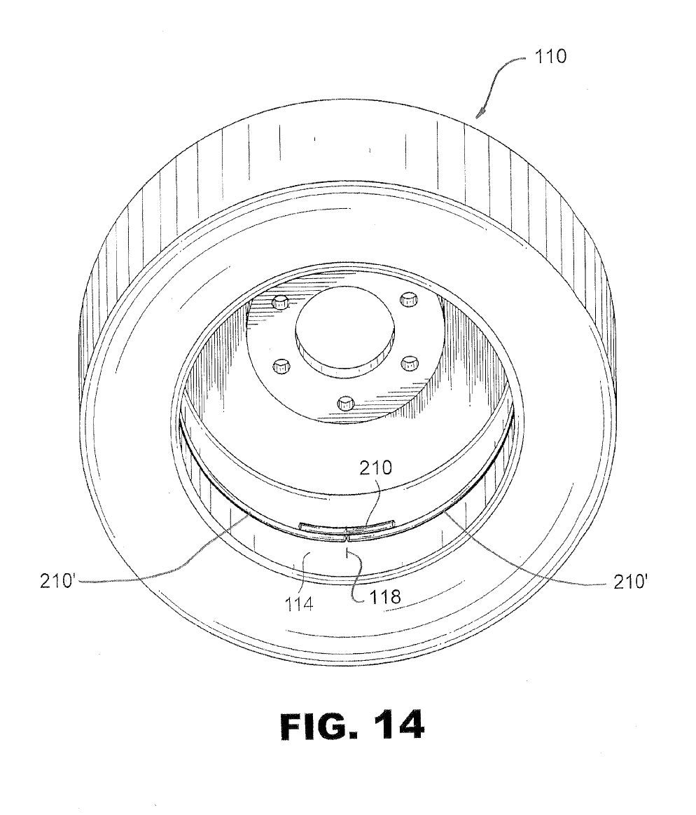

The marked arc 116 should be sufficient to properly align the weight 210. If the balancing procedure is completed first. A shorter arc 116 can be marked extending on either side of the marked imbalance location 118. If the marked arc 116 is made prior to balancing, the marked arc 116 is typically marked 360 degrees making an annular mark 116 completely around the wheel brake well 114 as best shown in FIG. 13. This provides a reference line for placement regardless of where the location of imbalance is determined by the balance machine.

In another embodiment, an annular ring of cartridges 210′ is added to the tire/wheel assembly 110. The tire wheel assembly 110 is first balanced with weight 210 along annular mark 116 as in the previous method described above. A plurality of cartridges 210′ are then positioned adjacent the annular mark 116, the cartridges 210′ are generally positioned end-to-end about the non-pressurized side of the wheel brake well 114 to form an annular ring of cartridges 210′, each cartridge 210′ comprising an interior chamber at least partially filled with a flowable media, wherein the cartridge is longitudinally arcuate, at least when attached to the tire/wheel assembly. As shown, the cartridges 210′ are 180 degree segments such that two cartridges 210′ make up the annular ring of cartridges 210′. It is contemplated that any number of cartridges 210′ could be used and that there could be a set spacing interval between the ends of the cartridges 210′ forming the annular ring. It is also contemplated that the cartridges 210′ forming the annular ring have interior chambers that are completely filled with media. The annular ring of cartridges 210′ provide additional stability to the tire/wheel assembly 110 by reducing the effects of vibration caused by both external (e.g. road bumps, etc.) and internal (e.g. tire non-uniformities, etc.) factors as well as reducing the noise transmitted through the tire/wheel assembly. The annular mark 116 made with tool 10 aids in proper placement of cartridges 210′ about the wheel brake well 114 (or the pressurized side of the tubewell if desired).

The tool 10 of the present invention can be designed to mark either the radial centerline of the wheel at either the brake well or the radial centerline of the tube well. It can also be used to mark a line parallel to the radial centerline when possible clearance problems with the brake caliper force the balance weights to be positioned nearer the inboard flange of the wheel.

Although the present invention has been described above in detail, the same is by way of illustration and example only and is not to be taken as a limitation on the present invention. Accordingly, the scope and content of the present invention are to be defined only by the terms of the appended claims.

What is claimed is:

1. A tool for marking a surface of a wheel having a rim flange, the tool comprising:
a base member having a register surface for engaging the rim flange of the wheel;
a bar extending from the base and spaced from the register surface of the base;
a marker removably attachable to the bar, the marker extending from the bar and adapted to mark the wheel when the register surface of the base engages the rim flange of the wheel.

2. The tool of claim 1, wherein the bar is perpendicular to the register surface of the base.

3. The tool of claim 1, wherein the marker is perpendicular to the bar.

4. The tool of claim 1, wherein the bar is adjustable with relation to the register surface of the base member to change the distance between the register surface and the marker.

5. The tool of claim 1 further comprising a plurality of graduation marks on the extension bar positionable such that when a graduation mark corresponding to the predetermined size of the wheel is aligned at a predetermined position, the distance from the register surface to the marker corresponds to a distance representing approximately half of width of the wheel.

6. The tool of claim 1 further comprising a plurality of graduation marks on the extension bar positionable such that when a graduation mark of the second plurality of graduation marks corresponding to the predetermined size of the wheel is aligned at a predetermined position, the distance from the register surface to the marker corresponds to a distance slightly offset from a radial centerline of the wheel.

7. The tool of claim 1, further comprising a handle attached to the base member.

8. The tool of claim 1, further comprising a screw adapted to fix the position of the bar with respect to the base member.

9. The tool of claim 1, further comprising a screw adapted to fix the position of the marker with respect to the bar.

10. A method of weight to a tire/wheel assembly comprising the steps of:
providing a tire/wheel assembly;
providing a tool comprising a base member having a register surface for engaging the rim flange of the wheel, a bar extending from the base and spaced from the register surface of the base, and a marker removably attachable to the bar, the marker extending from the bar;
positioning the register surface of the base of the tool against the rim flange of the wheel such that the marker contacts the non-pressurized side of the tubewell of the tire/wheel assembly;
moving either the tool or the wheel to mark at least an arc on the non-pressurized side of the tubewell of the tire/wheel assembly;
providing at least one weight, wherein the weight is longitudinally arcuate, at least when attached to the tire/wheel assembly; and
attaching the at least one weight to the non-pressurized side of the tubewell of the tire/wheel assembly along the marked arc.

11. The method of claim 10 further comprising the step of:
extending the bar of the tool from the base to a predetermined distance such that the marker positioned generally at the radial centerline of the wheel when the register surface of the tool is positioned against the rim flange of the wheel.

12. The method of claim 10 further comprising the step of:
determining a weight amount of an imbalance of the tire/wheel assembly and a location to correct the imbalance of the tire/wheel assembly using a tire/wheel assembly balancing equipment.

13. The method of claim 1 0, wherein the step of providing at least one weight is accomplished by providing a cartridge comprising an interior chamber at least partially filled with a flowable media, wherein the cartridge is longitudinally arcuate, at least when attached to the tire/wheel assembly.

14. The method of claim 13 further comprising the step of:
attaching at least a second cartridge comprising an interior chamber at least partially filled with a flowable media, wherein the cartridge is longitudinally arcuate, at least when attached to the tire/wheel assembly.

15. The method of claim 13 further comprising the step of:
attaching a plurality of cartridges end to end about the non-pressurized side of the tubewell of the tire/wheel assembly to form an annular ring of cartridges, each comprising an interior chamber at least partially filled with a flowable media, wherein the cartridge is longitudinally arcuate, at least when attached to the tire/wheel assembly.

16. A method of balancing a tire/wheel assembly comprising the steps of:
providing a tire/wheel assembly;
providing a tool comprising a base member having a register surface for engaging the rim flange of the wheel, a bar extending from the base and spaced from the register surface of the base, and a marker removably attachable to the bar, the marker extending from the bar;
determining a weight amount of an imbalance of the tire/wheel assembly and a location to correct the imbalance of the tire/wheel assembly using a tire/wheel assembly balancing equipment;
positioning the register surface of the base of the tool against the rim flange of the wheel such that the marker contacts the non-pressurized side of the tubewell of the tire/wheel assembly;
moving either the tool or the wheel to create at least an arc marking on the non-pressurized side of the tubewell of the tire/wheel assembly;
providing at least one weight comprising a cartridge comprising an interior chamber at least partially filled with a flowable media, wherein the cartridge is longitudinally arcuate, at least when attached to the tire/wheel assembly, about an angle of 180 degrees or less; and
attaching the at least one weight to the non-pressurized side of the tubewell of the tire/wheel assembly along the arc marking at the location to correct the imbalance of the tire/wheel assembly.

17. The method of claim 16, wherein the mark made during the step of moving the tool in relation to the wheel is a 360 degree annular mark.

18. The method of claim 16 further comprising the step of:
attaching a plurality of cartridges along the arc marking, the cartridges positioned end to end about the non-pressurized side of the tubewell of the tire/wheel assembly to form an annular ring of cartridges, each comprising an interior chamber at least partially filled with a flowable media, wherein the cartridge is longitudinally arcuate, at least when attached to the tire/wheel assembly.

19. The method of claim 16 further comprising the step of:
attaching at least a second cartridge adjacent the marked arc, the cartridge comprising an interior chamber at least partially filled with a flowable media, wherein the cartridge is longitudinally arcuate, at least when attached to the tire/wheel assembly.

20. The method of claim 16 further comprising the step of:
verifying that the tire/wheel assembly is balanced by using the tire/wheel assembly balancing equipment.
